(19) United States
(12) Patent Application Publication
(10) Pub. No.: US 2013/0217346 A1
(43) Pub. Date: Aug. 22, 2013

(54) SENSING AND COMMUNICATING DATA FROM MOVING ANIMALS

(71) Applicants: Robin Mark Freeman, London (GB); Tomasz Naumowicz, Berlin (DE)

(72) Inventors: Robin Mark Freeman, London (GB); Tomasz Naumowicz, Berlin (DE)

(73) Assignee: MICROSOFT CORPORATION, Redmond, WA (US)

(21) Appl. No.: 13/400,105

(22) Filed: Feb. 19, 2012

(51) Int. Cl. H04W 88/02

(52) U.S. Cl. 455/90.1

(57) ABSTRACT

Sensing and communicating data from moving animals is described. In various embodiments a logging and communications device is attached to a wild animal such as a bird; the device senses environmental, physiological or behavioral data about the animal and communicates that data wirelessly to other devices (be they on other animals in the environment or at a scientist's base station). This enables scientists to obtain empirical data about animals in their natural environment without disturbing that environment unduly and with improved data retrieval. In various embodiments the device is physically small and lightweight whilst incorporating sensors such as global positioning systems, pressure sensor, light sensor or others and may be used solely to retrieve data or for both logging and communications.

### BACKGROUND

Our understanding of the movements and distribution of animals in their environments is an ongoing research field. Understanding animal behavior in space and time is fundamental to our ability to preserve species and to predict their future behavior. This is especially important for species that may be vulnerable to environmental change as our understanding of the relationship between environment and movement and distribution is often unclear.

Scientists have previously collected data from animals in the wild in various ways, including manual observation, the use of satellite imaging, and attaching tracking devices onto animals. For example, transmission of data via satellite has been used to track the movements of Albatrosses. However, the use of satellites to remotely receive data is extremely expensive. There is an ongoing need to find ways of collecting data from moving animals in their natural environments which is low cost, flexible and enables collected data to be retrieved simply and efficiently.

The embodiments described below are not limited to implementations which solve any or all of the disadvantages of known devices and methods for sensing and communicating data from moving animals.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

Sensing and communicating data from moving animals is described. In various embodiments a logging and communications device is attached to a wild animal such as a bird; the device senses environmental, physiological or behavioral data about the animal and communicates that data wirelessly to other devices (be they on other animals in the environment or at a scientist's base station). This enables scientists to obtain empirical data about animals in their natural environment without disturbing that environment unduly and with improved data retrieval. In various embodiments the device is physically small and lightweight whilst incorporating sensors such as global positioning systems, pressure sensor, light sensor or others and may be used solely to retrieve data or for both logging and communications.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a sea bird (such as a Manx shearwater) with a logging and communications device attached to its back;

FIG. 2 is a schematic diagram of a colony of sea birds in an environment and a scientist monitoring data from logging and communications devices on some of the birds;

FIG. 3 is a schematic diagram of a logging and communications device;

FIG. 4 is a flow diagram of a method at a logging and communications device;

FIG. 5 is a flow diagram of a method of downloading data from a logging and communications device;

FIG. 6 is a state transition diagram of a process implemented at a logging and communications device;

FIG. 7 is a first part of a state transition diagram of a process implemented at a device acting in as a base station;

FIG. 8 is a second part of the state transition diagram of FIG. 7;

FIG. 9 is a schematic diagram of printed circuit board implementing a logging and communications device;

FIG. 10 illustrates an exemplary computing-based device in which embodiments of a base station may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in a logging and communications device used on birds for tracking their location, the system described is provided as an example and not a limitation. As those skilled in the art will appreciate, the present examples are suitable for application in a variety of different types of logging and communications devices used on other animals and to log other types of data which may be sensed from the environment and/or from the animal (in terms of either or both of its physiology and behavior).

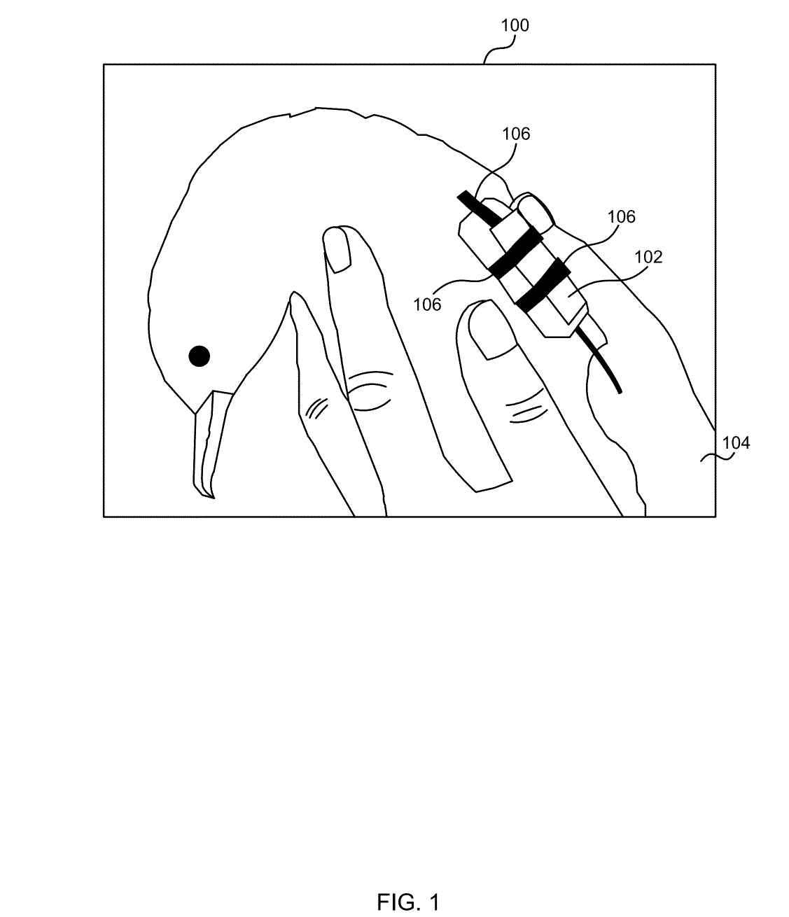

FIG. 1 is a schematic diagram of a sea bird 100 (such as a shearwater) with a logging and communications device 102 attached to its back using tape 106. The device senses environmental, physiological or behavioral data about the bird and communicates that data wirelessly to other devices (be they on other animals in the environment or at a scientist's base station). This enables scientists to obtain empirical data about animals in their natural environment without disturbing that environment unduly. The logging and communications device is standalone and may be attached to animals in a variety of ways with any disturbance to the animal being minimized. Scientists obtain appropriate permissions before using the devices and act ethically and with full consideration for animal well being.

In this example the bird 100 is being held in the hands 104 of a person. The logging and communications device is sized and shaped to be attached to a wild bird or other animal in order that any disturbance is minimized. The weight of the device is low in relation to the animal's weight so that the animal is able to travel and move as it normally would. The device is low cost so that it may be deployed on animals in recognition of the fact that the device may not be retrieved at the end of the study and also that it may have a limited working life (due to loss of power or damage). For example, the device may be attached to the animal in such a way that it is expected to fall off after a few days so that it is not necessary to catch the animals and remove the devices. This minimizes disturbance of the animals by interaction with humans. In this example the device is attached to a shearwater. It may also be attached to other types of bird such as pigeons and other birds or to other types of animal including sea creatures and land animals. The device may be placed in a waterproof or other protective housing according to the environment of the animal being studied.

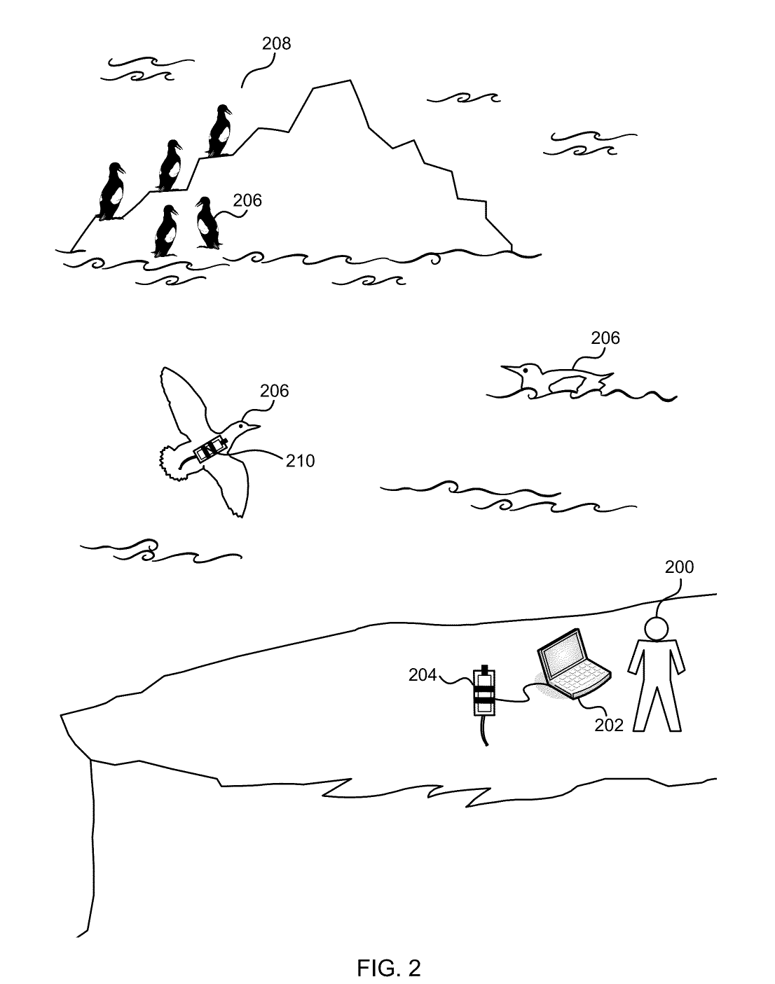

FIG. 2 is a schematic diagram of a colony of sea birds 208 in an environment and a scientist 200 monitoring data from logging and communications devices 210 on some of the birds 206. The scientist attaches the logging and communications devices 210 onto some of the birds 206 in the colony. The birds carry on their normal behavior and the devices 210 log sensed data about the bird's environment and/or physiology and/or behavior. For example, the devices track the location of the birds using a GPS receiver and sense the ambient light levels and the ambient pressure. However, these are examples only. Other data may be sensed.

Each logging device may be configured as a base station and left alone to act as an autonomous data collection device. It communicates with deployed logging devices and downloads the logged data. A scientist 200 with a portable computer 202 attached to one of the logging and communications devices 204 which is configured as a base station is able to receive data from logging and communications devices deployed on the birds. For example, the devices use wireless communications technology enabling communications over ranges of the order of a kilometer or of the order of 100s of meters depending on the type of antennas used on the devices. This enables a scientist to track individual birds for example, and to monitor how much data has been sensed at those individuals and how much power is left at individual devices. Logged data from the devices on the birds may be downloaded to the device 204 at the portable computer.

Because logged data may be transferred between devices on the animals as they are moving about it is possible for the scientist retrieve more data than has previously been possible. This increases the proportion of all the logged data which is recovered by the scientist. For example, if ten devices each on a different bird log data, and later the devices fall off 3 birds and fail on 1 bird then previously, the scientist would have been able to obtain data from 6 birds (in the best case where the scientist was able to download the data from all 6 devices). Where logged data is shared between devices (as birds fly in proximity or roost in proximity) then the scientist is able to retrieve a greater proportion of all the logged data.

The scenario depicted in FIG. 2 is an example only and many other situations are possible. For example, the devices may be attached to homing pigeons and logged data may be transferred between pigeons as they are within communication range of each other in flight. In other examples the devices are attached to mammals, fish, or other animals which live in colonies or tend to travel or move in groups.

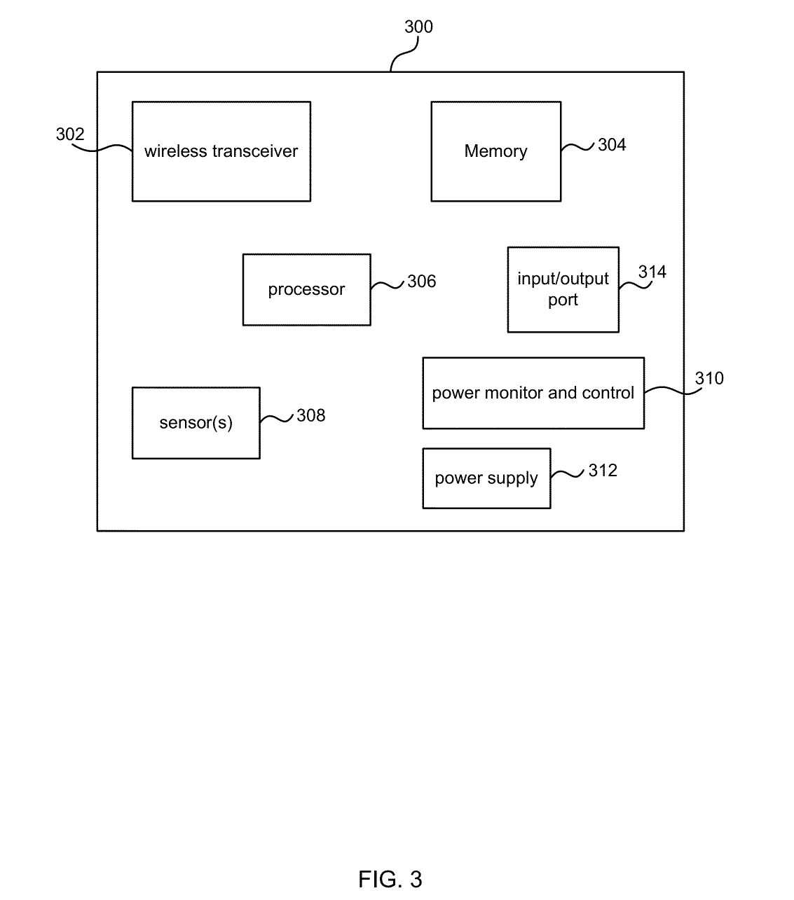

FIG. 3 is a schematic diagram of a communications device 300. The device may be used:

As a base station for retrieving logged data from other devices; or

As a logger for logging data at the animal and sending the logged data to a base station; or

As a combined base station and logger which sends and receives logged data with other devices.

By enabling the same communications device 300 to be used in these different ways manufacturing costs are reduced since only one device needs to be manufactured.

The communications device 300 comprises a wireless transceiver 302 which enables wireless communications with other communications devices for sending and/or receiving data logged from the sensors, control information, and optional summary information about the logged data and power supply status. The wireless transceiver may have a communications range of up to 1 km in some embodiments. In other embodiments the communications range may be several 100 meters. The communications range depends on the type of antenna used by the wireless transceiver and the choice depends on the characteristics of the animal and environment under study.

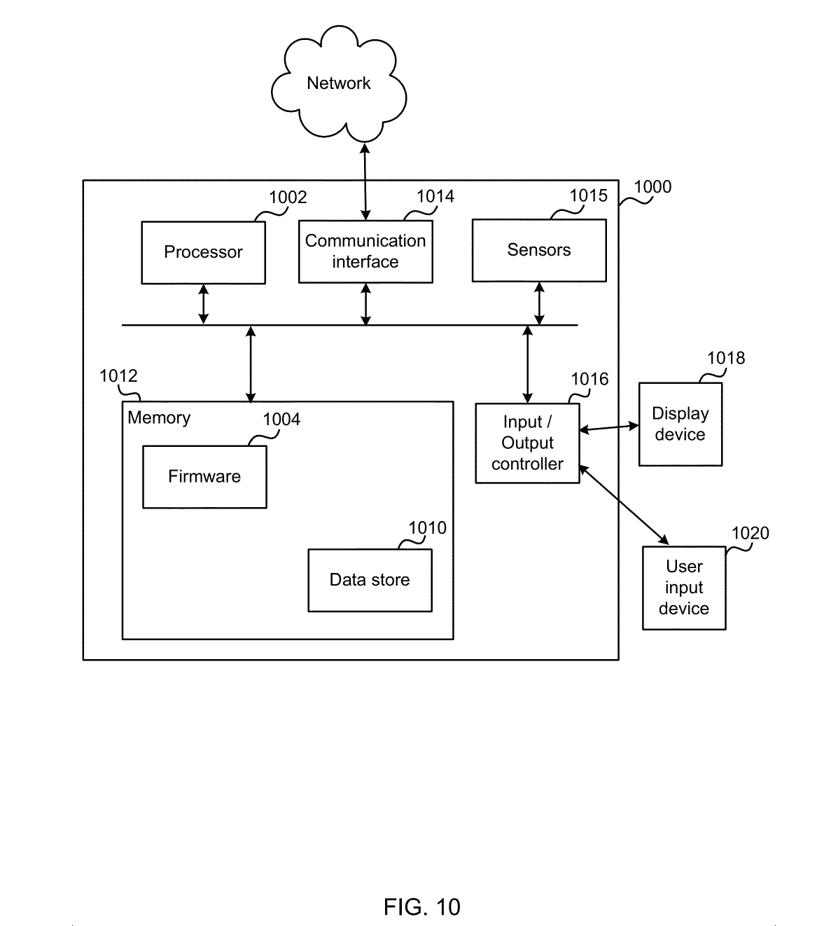

The communications device 300 comprises a memory 304 for storing logged data, instructions for execution by the processor, logging regime parameters, and other information for operation of the device. The memory may be flash memory or other types of memory as mentioned in more detail below with reference to FIG. 10. The device comprises an input/output port 314, for example, to enable the device to be connected to a portable computer as illustrated in FIG. 2. The input/output port is of any type which enables data from the device to be output (such as logged data, control data, status information and other data) and data to be input to the device such as parameter settings, updates to logging regimes, and instructions for controlling the device.

The communications device 300 comprises a processor 306 which may be a microprocessor or any other suitable processor for controlling the wireless transceiver, sensors and memory.

The communications device 300 comprises at least one sensor 308. A non-exhaustive list of examples of sensors is any combination of one or more of: light sensor, ambient temperature sensor, pressure sensor, accelerometer, gyroscope, compass, camera, video camera, microphone, global positioning system, heart beat monitor, body temperature sensor, or others. The processor may implement a logging regime specified by the scientist for logging data from sensors at specified time intervals and/or in specified conditions. At any one time, one or more of the sensors may be automatically disabled by the processor to reduce power consumption with the ability to wake up disabled sensors (for example, to react to external events).

The communications device 300 comprises a power monitor and power control unit 310 which is able to monitor the status of a power supply 312 for example. The power control unit 310 may adjust the voltage of power output from the power supply 312 and/or enable the power supply 312 to be recharged when the device is retrieved by the scientist. For example, the power supply 312 may be a battery. The power supply may comprise a solar power supply, or other power supply which obtains power from the environment of the animal and/or from motion of the animal itself

In an example, the communications device 300 is in the form of a printed circuit board. For example, it comprises a support structure arranged to support the device and enable it to be attached to an animal moving in an environment. The support structure holds one or more sensors 308 which sense any of the behavior, physiology or environmental conditions of an animal to which the device is attached in use. The device has a memory 304 which stores data output from the sensor(s). It also has a wireless transceiver 302 arranged to send at least some of the stored data to a second communications device attached to another animal moving in the environment and to receive sensor data from the second communications device. The processor 306 may be arranged to control the transceiver, sensors and memory in order to log data from the sensors according to a logging regime.

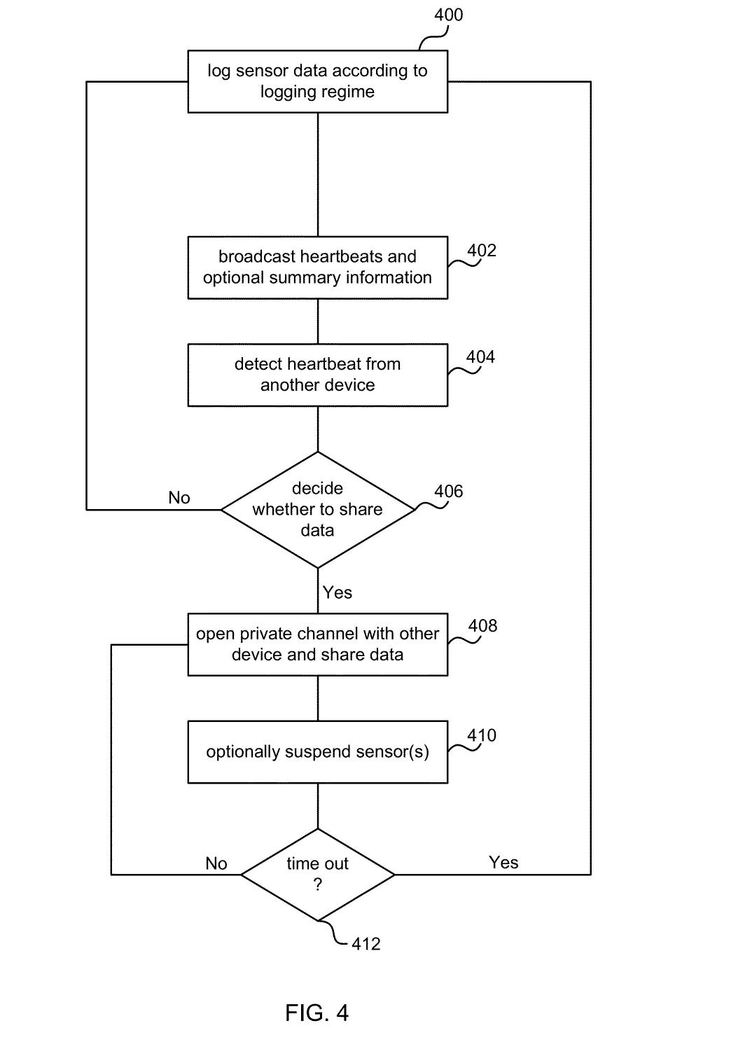

FIG. 4 is a flow diagram of a method at a logging and communications device such as the device 300 of FIG. 3 when used to log data and share logged data with another device. The device logs 400 sensor data according to a logging regime specified at the device. For example, the scientist may have pre-configured the logging regime at the device as described in more detail below. The logging regime specifies when to log data and how much data to log.

Once the device has logged a threshold amount of data it broadcasts 402 heart beat messages and optionally summary information. The heart beat messages are broadcast on a communications channel available to all other devices being used by the scientist. The communications channel available to all devices may be referred to as a globally shared communications channel. The heart beat messages may be of any type suitable to inform other entities that the device is within communications range and has logged data. The heart beat messages may comprise an identity of the device broadcasting the heart beat. The heart beat messages are repeatedly broadcast by the device at intervals. The device optionally broadcasts summary information such as battery status, uptime (how long the device has been active for), amount of data logged, averages of logged data per sensor, amount of data received from other devices, or other summary information. This summary information may be broadcast as part of the heart beat messages or separately from the heart beat messages.

The device monitors the globally shared communications channel. If the device detects 404 a heart beat from another device on that channel it decides 406 whether to share data with the detected device. For example, this decision is made according to how much data has been logged. If the device does decide to share data then it opens 408 a private channel with the other device and shares data with that device over the private channel. For example, each device has a wireless communications channel assigned to it which is unique amongst a group of devices which the scientist is using for the study. The device uses its assigned channel to open a private communications channel with the detected device. The channel is private in the sense that no other devices in the group will be using that channel and so interference from other devices will be minimized.

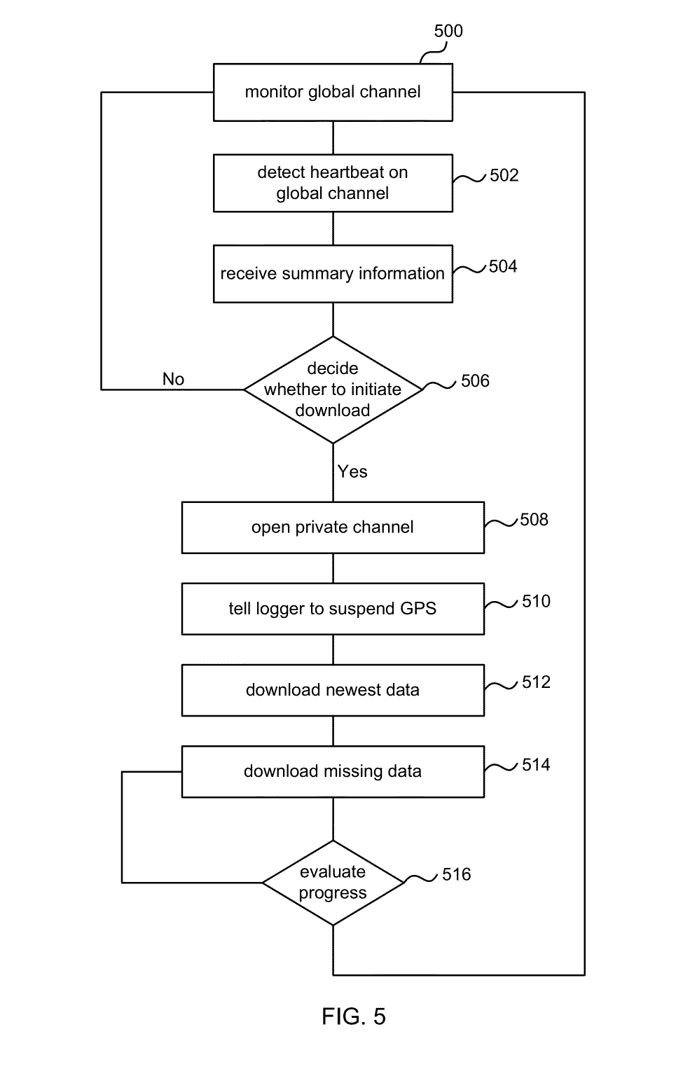

The process of sharing data between the devices comprises synchronizing the logged data between the devices. This may be achieved in any suitable manner. An example is described below with reference to FIG. 5 where the newest data is transferred first. One or more of the sensors may optionally be suspended 410 during the process of sharing the data in order to conserve power. However, that is not essential.

The process of sharing data may timeout 412 after a specified time interval or may end due to the devices becoming out of range or the data having been fully synchronized. The device then returns to logging 400 sensor data according to the logging regime.

FIG. 5 is a flow diagram of a method of downloading data from a logging and communications device. The method may be carried out at one of the logging and communications devices described herein when it is being used as a base station either at a static location in the environment, or attached to an animal or other entity moving in the environment.

The device monitors 500 a global communications channel that is known to each of the devices being used in the study. The device may detect 502 one or more heart beat messages on the global channel indicating that one or more other devices are within communications range. The device may also receive 504 summary information as part of the heart beat messages or separately. The summary information may comprise a summary of one or more types of data logged at the device which broadcast the summary information and optionally other information such as power supply status. The device decides 506 whether to initiate download with one of the detected devices and which of the detected devices to select. Rules, criteria or thresholds may be configured at the device for enabling the decision and selection to be made. For example, download may only be initiated if the detected device has more than a threshold amount of logged data. In another example, a device with lower power may be selected for download in priority over those with high power in order to try to retrieve as much data as possible from the low power device before that becomes impossible.

To initiate download a private channel may be opened 508 between the device acting as a base station and the selected in-range device. For example, each base station in the group of devices being used in the study may have a channel unique to that base station. The base station uses that channel to communicate with the selected in-range device and this reduces interference. However, it is not essential to use a private channel in this manner. The download may take place over the global channel known to all devices in the group.

The base station may send a message to the selected in-range device requesting that it suspend 510 its sensors (such as its global positioning system if one is present) in order to conserve power whilst the download takes place.

Once a communications channel is established between the base station and the selected in-range device the base station proceeds to download 512 the newest data logged at the in-range device. As this logged data is the newest it is unlikely to already have been downloaded to the base station. By downloading the newest data the need for communication between the two entities to establish which data needs to be downloaded is avoided and this improves efficiency. This is especially useful where animals are moving and the two devices may be in communications range of one another for a very limited period of time.

Once the newest data has been downloaded the base station proceeds to download missing data; that is any data present at the in-range device which is not already present at the base station. To identify the missing data, messages are communicated between the devices to establish which data is missing. An example of a synchronization process which may be used is given below. For example, the in-range device may send summary information to the base station identifying time stamp ranges of data it has available and the base station may then request time stamp ranges of data that it requires. If the in-range device has data from other devices besides itself it may also send identifiers of the other devices and summary information about the data it has from those other devices. The download process may be evaluated 516 at the base station in order to check whether it should proceed.

An example of a synchronization process which may be used to communicate data between the devices is now given.

Each log entry may have three identifiers (IDs) as follows:

L1: ID of the device that the data was recorded on;

L2: ID of the device that stored the data before it was transferred to a new device (at first, L1 and L2 are equal as the data is recorded on the same device that stored the data);

L3: a sequence ID (counter) (unique only on the device that initially recorded the data).

An example synchronization process comprises the following steps:

First, a bulk data transmission is requested (for example step 512 in FIG. 5) whereby the base station asks the logging and communications device to deliver data within a range of sequence IDs. For example, “device with ID5, please send me data you stored between sequence 1 and sequence 5000”.

At the base station each received log entry is stored. Some data is usually lost during the transmission due to packets being dropped over the wireless communications link. The base station stores each log entry received and stores the ID of the transmitting device under L2. This is useful as the base station might later be loading data from a different device and is then able to distinguish between the data sources.

The base station reads through its entire storage and keeps track whether there are any missing sequence IDs from the selected device. It expects to find all log entries with sequence IDs between 1 and 5000 except for some losses due to dropped packets. Each found sequence ID may be stored in memory at the base station. After a finished scan the missing sequence IDs are known as they were not marked as the found ones. The base station constructs a request for the missing entries. As the size of a wireless communications packed is limited and also a quick (in terms of time) communication is required, the following method may be used:

The sequence ID of the first missing entry is sent from the base station to the logging device, followed (in the same message packet) by a Boolean bit-array that describes whether the following sequence IDs are missing or not. This enables the base station to request up to few hundred log entries with a single request message. This may be repeated until the whole range of the requested log entries is processed. In the example discussed above this corresponds to proceeding until all log entries with sequence IDs between 1 and 5000 are processed once.

Repeated requests for missing log entries may be made until either a threshold of the number of missing entries (in percent) is reached or a maximal number of retries is reached.

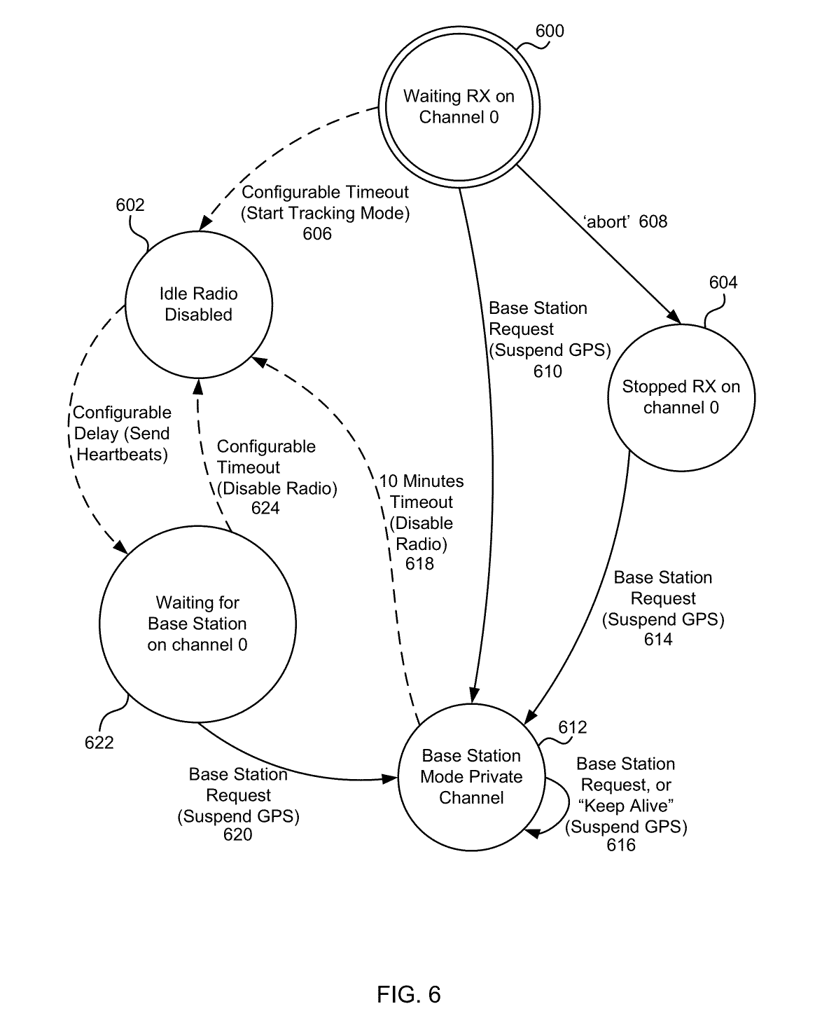

FIG. 6 is a state transition diagram of a process at a logging and communications device such as those described herein. The process excludes the logging regime which may be considered independently of the communications process represented in the state transition diagram. Each circle in the diagram indicates a state that the device may be in and arrows between the states indicate how the device may change from one state to another according to specified conditions. The dotted arrows indicate transitions between states that may occur according to time characteristics such as timeout periods or delays.

The logging and communications device enters the double circle state 600 when it is powered on. In this initial state the device waits to receive on a global channel shared by a plurality of communications devices being used in a study. When in state 600, if the logging and communications device receives a request 610 from a base station trying to open a private communications channel with the device then the state may change to state 612. When in state 600, if the logging and communications device detects an “abort” event 608 it transitions to state 604 and stops receiving on a global channel (channel 0). An abort event occurs according to user input from a scientist. For example, the scientist user input may be submitted locally when the device is connected directly to a personal computer over a communication cable. In this manner the device is able to accept commands submitted as text at the personal computer and data may be downloaded from the device to the personal computer over the cable. In other examples the abort event occurs according to user input from a scientist using wireless communications. An abort event enables a scientist or researcher to stop the default logging and communications mode and investigate data stored on the device. This may be useful when no base station is available. From state 604 it is able to transition to communication with a base station over a private channel (state 612) if a base station request 614 is received. The base station request may comprise a request to suspend one or more sensors at the device to save power.

When in state 600, if the logging and communications device reaches a timeout 606 it transitions to state 602 where it is idle with the wireless transceiver disabled to save power. State 602 may be a low power sleep mode during which the device saves power but may be awakened by events such as a time delay. After a configurable delay it transitions to state 622 and sends 626 heart beat messages on the global channel. In state 622 the device waits for a base station request on the global channel. If no base station request is received after a timeout 624 the device transitions back to state 602. If a base station request is received 620 then the device transitions to the base station mode state 612. Whilst in the base station mode 612 the device may remain in this state by receiving more base station requests 616. It may move back to the idle state 602 after a timeout 618 during which no base station requests 616 are received.

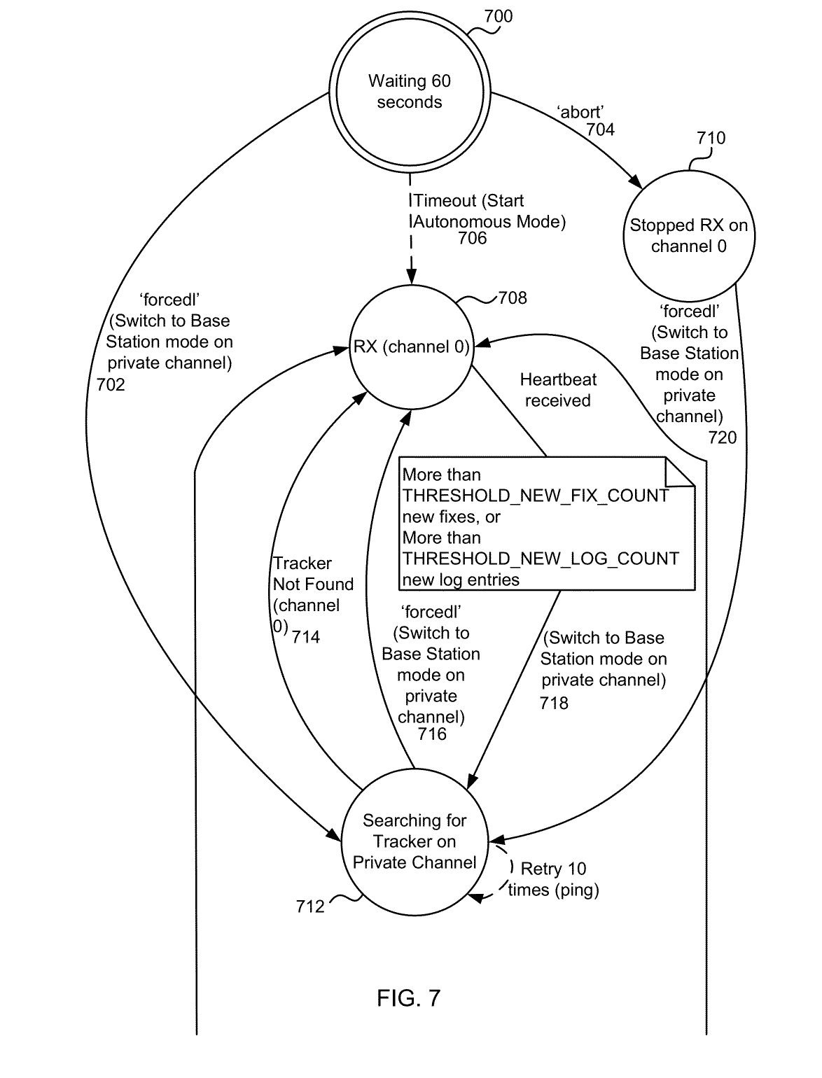

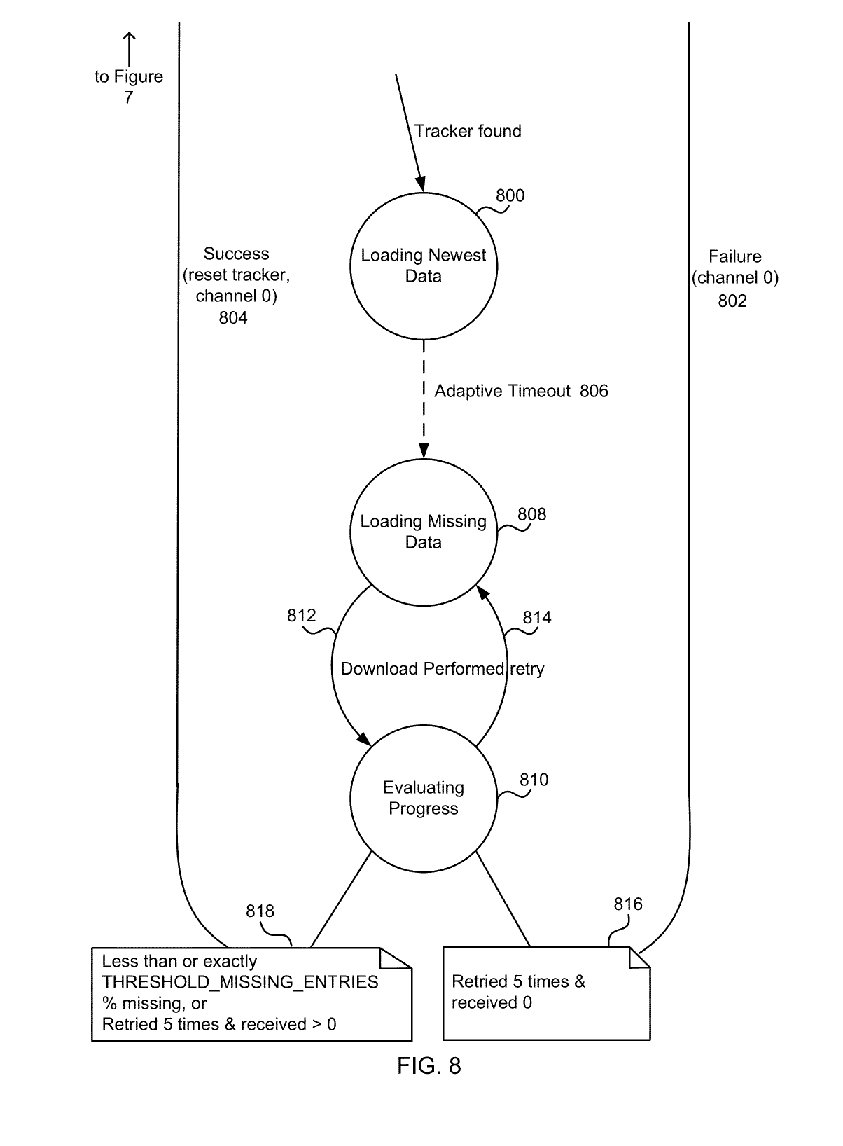

FIGS. 7 and 8 together form a state transition diagram of a process at a logging and communications device such as those described herein which is acting as a base station. The process excludes the logging regime which may be considered independently of the communications process represented in the state transition diagram. As for FIG. 6 each circle in the diagram indicates a state that the device may be in and arrows between the states indicate how the device may change from one state to another according to specified conditions.

When the base station is powered on it enters initial state 700 indicated by the double circle. During this initial state it waits for 60 seconds (or some other time) for user input. If user input is received 702 it transitions to state 712 where the device searches for other devices on its private channel. From the initial state 700, if no user input is received and after a timeout 706 the device moves to state 708 during which it receives any communications broadcast on the global channel which reach it. From the initial state 700, the device may receive an “abort” event 704 and move to state 710 where it stops receiving on the global channel. If it then receives a “forcedl” event 720 it moves to the state 712 and searches for another device on its private channel. A “forcedl” event occurs as a result of user input from a scientist wirelessly or over a cable connection from a personal computer to the device.

When the base station is in state 712, during which it is searching for another entity sending messages on its private channel, it moves back to state 708 if no other entity is found sending messages on the private channel. If another entity is found sending messages on the private channel then the state changes to stage 800 (see FIG. 8).

When the base station is in state 708 it is able to move to state 712 if a “forcedl” event occurs 716. It is also able to move to state 712 if summary information is received 718 associated with a heart beat which indicates that another device is in range which has more than a threshold amount of new data.

With reference to FIG. 8, during state 800 the base station downloads the newest data from the other entity on the private channel. After an adaptive timeout 806 it moves to state 808 during which missing data is downloaded. (More detail about the adaptive timeout is given below. For example, the timeout may be related to the number of log entries to be downloaded.) If a download is performed 812 then an evaluation state 810 is entered during which the device assessed the evaluation progress. As a result of the evaluation a retry 814 may occur causing the state to return to state 808. If the evaluation indicates that several retries have been unsuccessful 816 then the state returns to 708 as there has been a failure 802. If the evaluation indicates that all the missing data has been downloaded or partially downloaded after several attempts then a success event 804 has occurred and the state returns to state 708.

More detail about the adaptive timeout is now given. In an example, an adaptive timeout may be used such that requesting more log entries leads to a larger timeout and requesting fewer log entries leads to a smaller timeout. Due to the specifics of radio communication, there is no way to guarantee that a message sent from device A to device B was delivered. For example, when a base station requests data from a logging and communications device, it can't be sure whether the request was received by the logging and communications device. Also, there is no reliable way for the logging and communications device to notify the base station about a data transfer that was completed. This means that a base station estimates when a download is complete. For example, it may estimate the number of seconds required for the data transfer by multiplying the number of requested log entries with a number of seconds required to transfer one log entry. Optionally a safety buffer of few seconds may be added.

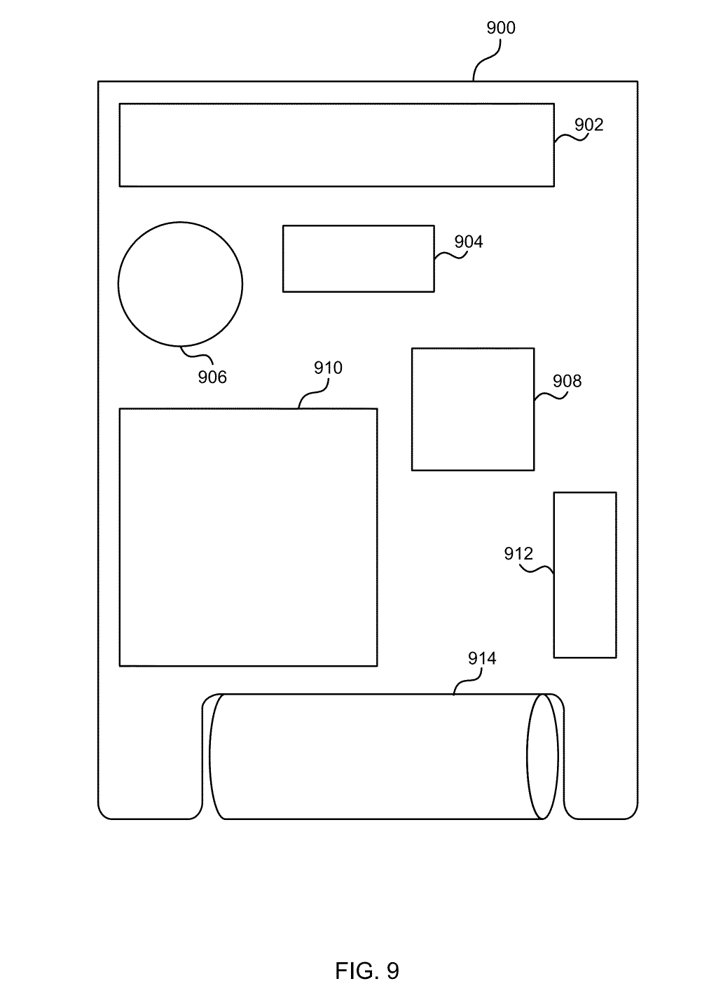

FIG. 9 is a schematic diagram of printed circuit board 900 implementing a logging and communications device. The printed circuit board may be sized and shaped and of a suitable weight for an animal to wear without affecting the animals' behavior. In one example the printed circuit board (including GPS, pressure sensor and light sensor) is of dimensions 40×22×0.5 mm and of weight 6 g excluding the battery. However, this is an example only; other sizes and weights of printed circuit board may be used depending on the sensors used and the type of animal and environment being studied.

In the example shown in FIG. 9 the printed circuit board comprises an antenna 902 for the wireless transceiver, a pressure sensor 906 a light sensor 904, a wireless communications chip 908 for controlling the antenna 902, a GPS chip 910 and a GPS antenna 914. The GPS antenna 914 is cylindrical in this example and fits into a recess in the printed circuit board. An input/output port 912 is also shown. On the reverse side of the printed circuit board a micro processor and a flash memory unit are provided.

In another embodiment the GPS functionality is provided using an integrated GPS chip and antenna.

In an example two main firmware types are provided for the printed circuit board. A first type of firmware may be for logging and communications; that is individual devices which sense and log data and communicate with other devices to send and/or receive logged data. A second type of firmware may be for base stations which may not be required to record their own data from the sensors.

The firmware may be dynamically updated on devices during use on animals. For example, a scientist is able to update timeout parameters and other parameters and thresholds of the firmware and send these updates to individual devices (for example using private channels) or to all devices (for example over the global channel). The updates may propagate through the population of devices in the field by being communicated between devices in a peer-to-peer fashion.

In other examples a scientist is able to send entirely new firmware to the devices in the field during use. In this case a re-flash is triggered at devices which receive the new firmware. This is useful where a scientist needs to implement a new state transition process at the devices rather than merely updating parameters used by existing state transition processes at the devices. The new firmware may be communicated between devices in the field in a peer-to-peer fashion.

An integrated development environment may be available to scientists to enable them to create or modify source code and compile that to form firmware for the device.

FIG. 10 illustrates various components of an exemplary computing-based device 1000 which may be implemented as any form of a computing and/or electronic device, and in which embodiments of a base station or a logging and communications device may be implemented.

Computing-based device 1000 comprises one or more processors 1002 which may be microprocessors, controllers or any other suitable type of processors for processing computer executable instructions to control the operation of the device in order to communicate data between moving animals; or to sense, log and communicate data between moving animals. In some examples, for example where a system on a chip architecture is used, the processors 1002 may include one or more fixed function blocks (also referred to as accelerators) which implement a part of the method of communicating data between moving animals in hardware (rather than software or firmware). Firmware 1004 or an operating system or any other suitable platform software may be provided at the computing-based. Data store 1010 is available to store sensor data log entries, parameters, logging regimes and other data.

The computer executable instructions may be provided using any computer-readable media that is accessible by computing based device 1000. Computer-readable media may include, for example, computer storage media such as memory 1012 and communications media. Computer storage media, such as memory 1012, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 1012) is shown within the computing-based device 1000 it will be appreciated that the storage may be distributed or located remotely and accessed via a network or other communication link (e.g. using communication interface 1014).

The computing-based device 1000 also comprises an input/output controller 1016 arranged to output display information to a display device 1018 which may be separate from or integral to the computing-based device 1000. The display information may provide a graphical user interface. The input/output controller 1016 is also arranged to receive and process input from one or more devices, such as a user input device 1020 (e.g. a mouse, keyboard, camera, microphone or other sensor). In some examples the user input device 1020 may detect voice input, user gestures or other user actions and may provide a natural user interface. This user input may be used to change parameter settings, view logged data, access control data from the device such as battery status and for other control of the device. In an embodiment the display device 1018 may also act as the user input device 1020 if it is a touch sensitive display device. The input/output controller 1016 may also output data to devices other than the display device, e.g. a locally connected printing device.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A communications device comprising:
a support structure arranged to support the device and enable it to be attached to an animal moving in an environment; the support structure holding:
one or more sensors which sense any of the behavior, physiology or environmental conditions of an animal to which the device is attached in use;
a memory which stores data output from the sensor(s);
a wireless transceiver arranged to communicate with a second communications device attached to another animal moving in the environment and to send or receive sensor data with the second communications device;
a processor arranged to control the transceiver, sensors and memory in order to log data from the sensors according to a logging regime.

2. A communications device as claimed in claim 1 wherein the processor is arranged to broadcast heart beat messages and summary information on a communications channel known to a plurality of communications devices including the second communications device; the summary information comprising information about an amount of sensor data at the memory.

3. A communications device as claimed in claim 2 wherein the summary information comprises information about power available at the device.

4. A communications device as claimed in claim 1 wherein the wireless transceiver is arranged to detect heart beat messages and summary information from other devices in the environment ; the summary information comprising information about amount of sensor data at the memory of other devices.

5. A communications device as claimed in claim 4 wherein the processor is arranged to decide whether to communicate sensor data with other devices in the environment according to the summary information.

6. A communications device as claimed in claim 1 wherein the sensors comprise at least a global positioning system and wherein the weight of the device is six grams or less.

7. A communications device as claimed in claim 1 wherein the sensors comprise a global positioning system, a pressure sensor and a light sensor and wherein the weight of the device is six grams or less.

8. A communications device as claimed in claim 1 which is arranged to enter a low power sleep mode from which it is able to awaken in response to one or more specified events.

9. A communications device as claimed in claim 1 wherein the sensors comprise at least a global positioning system and wherein the size of the device is 40 mm by 22 mm by 0.5 mm or less.

10. A communications device comprising:
a printed circuit board arranged to support the device and enable it to be attached to an animal moving in an environment; the printed circuit board having:
one or more sensors which sense any of the behavior, physiology or environmental conditions of an animal to which the device is attached in use; the sensors comprising a global positioning system;
a memory which stores data output from the sensor(s);
a wireless transceiver arranged to communicate with a second communications device attached to another animal moving in the environment and to send or receive sensor data with the second communications device;
a processor arranged to control the transceiver, sensors and memory in order to log data from the sensors according to a logging regime; and wherein the communications device weighs up to 6 grams.

11. A method at a communications device comprising:
monitoring a communications channel used by a plurality of other communications devices worn by animals moving in an environment;
receiving, from one or more of the other devices, heart beat messages and summary information at the communications channel;
deciding whether to establish a communications channel with a selected one of the other devices according to the heart beat messages and summary information;
establishing a communications channel with the selected one of the other devices using a communications channel unique to the communications device;
receiving sensor data from the selected one of the other devices over the established communications channel.

12. A method as claimed in claim 11, the summary information comprising information about an amount of sensor data, and the step of deciding whether to establish a communications channel comprises assessing whether the amount of sensor data indicated in the summary information is above a threshold.

13. A method as claimed in claim 11, the summary information comprising information about power availability and the step of deciding whether to establish a communications channel comprises assessing whether the power availability is below a threshold.

14. A method as claimed in claim 11 comprising receiving sensor data from the selected one of the other devices such that newest sensor data is received first.

15. A method as claimed in claim 11 comprising receiving sensor data from the selected one of the other devices such that newest sensor data is received first and then requesting any missing sensor data by sending a packet to the selected one of the other devices, the packet comprising a sequence ID of a first missing sensor data followed by a Boolean bit-array that describes whether following sequence IDs are missing or not.

16. A method as claimed in claim 11 comprising evaluating the process of receiving sensor data from the selected one of the other devices.

17. A method as claimed in claim 11 comprising suspending operation of one or more sensors at the device.

18. A method as claimed in claim 11 comprising sensing data using sensors at the device, saving the data at a memory integral with the device and sending the data saved at the memory over the established communications channel.

19. A method as claimed in claim 11 comprising sending updated firmware to the selected device over the established communications channel.

20. A method as claimed in claim 11 comprising sending updated parameters to the selected device over the established communications channel.
